(19) United States
(12) Patent Application Publication
(10) Pub. No.: US 2021/0308618 A1
(43) Pub. Date: Oct. 7, 2021

(54) SYSTEM AND METHOD FOR RECOVERY OF CARBON DIOXIDE

(71) Applicant: CARBONREUSE FINLAND OY, Savonlinna (FI)

(72) Inventor: Juha SILVENNOINEN, Savonlinna (FI)

(21) Appl. No.: 17/331,714

(22) Filed: May 27, 2021

Related U.S. Application Data
(63) Continuation of application No. PCT/FI2019/050864, filed on Dec. 2, 2019.

(30) Foreign Application Priority Data
Nov. 30, 2018 (FI) 20186030

(51) Int. Cl. B01D 53/14

(52) U.S. Cl. CPC B01D 53/1475; B01D 53/1425; B01D 2258/0283; B01D 2252/103; B01D 53/1418

(57) ABSTRACT

A method for the recovery of carbon dioxide includes the steps of pressurizing the carbon dioxide-containing gas, supplying the pressurized gas to an absorption step, wherein the carbon dioxide contained in the pressurized gas is absorbed into water in an absorption tank, circulating the water produced in the absorption step, into which water carbon dioxide is absorbed from the absorption tank to the desorption step, wherein in the desorption step, carbon dioxide absorbed in water is desorbed from water, and recovering carbon dioxide desorbed from water by means of a first desorption tank and a second desorption tank, wherein a lower pressure is applied in the second desorption tank than in the first desorption tank.

### CROSS-REFERENCE TO RELATED APPLICATIONS

This application is a continuation of PCT International Application No. PCT/FI2019/050864 filed Dec. 2, 2019, which claims priority to Finnish Patent Application No. 20186030, filed Nov. 30, 2018, the disclosure of each of these applications is expressly incorporated herein by reference in their entirety.

### OBJECT OF THE INVENTION

The invention relates to a method for recovering carbon dioxide from a gas containing it and to a system for recovering carbon dioxide from a gas containing it. In particular, the invention relates to a carbon recovery method and system utilizing two desorption tanks.

### PRIOR ART

The recovery of carbon dioxide has traditionally involved the use of a so-called fill block column. It comprises a sizable tank filled with loose blocks. From a top end of the tank is poured water so as to soak the loose blocks, and from a bottom end is supplied a flue gas or the like carbon dioxide containing gas. The surface of the loose blocks constitutes a large area, thereby enhancing the absorption or desorption taking place at an interface between gas and water. Gas and water are supplied from the opposite ends for the purpose of generating a so-called countercurrent process, in which the concentration gradient remains high across the entire column. In boilers, the same countercurrent principle is referred to as superheating. A drawback with the fill block column is a remarkably large size and thereby also the purchase price.

The general principle of a recovery process is that the process comprises an absorption column in which carbon dioxide is absorbed into water and other gases pass through the column and are conducted into a smokestack. Such selectivity is a result of different gases having a different absorption capability into water, according to Henry's law. The flue gas contains mainly nitrogen, as does also the air used in combustion, but oxygen present in the air converts into carbon dioxide in the combustion process. Carbon dioxide is absorbed into water by approximately hundredfold with respect to nitrogen and the absorption rate of possible oxygen lies between those two.

The water saturated with carbon dioxide is conducted from the absorption column to the desorption column with an effort to provide in the latter such conditions that carbon dioxide reconverts back into gas. As known, absorption and desorption are influenced by temperature and pressure, as well as by the partial pressures of gases. By establishing a reasonably high pressure in the absorption column or tank and/or by using cold water, the result will be a good absorption, and in a reverse case, i.e. a low pressure and/or a higher temperature in the desorption column or tank, the gas is enabled in desorption to remove itself from water and to become a gas again. Both the pressurization and the change of temperature require energy and, hence, must be used prudentially.

Carbon dioxide recovery is described, for example, in patent publications FI 124 060 and FI 127 351. Both patents relate to the use of gases with a low carbon dioxide concentration, typically for example in the power plant flue gases. The carbon dioxide concentration of the power plant flue gas is determined by the carbon dioxide produced by the combustion air and is often limited to 10-15%. This is because the purity of the combustion requires the use of extra air, so that carbon dioxide is diluted. The central problem here is the raising of the partial pressure of carbon dioxide, which is what these patents are about.

In the auxiliary adsorption column according to patent FI 124 060, carbon dioxide remaining in the desorption column of the circulating water can be advantageously removed when a raw gas with a sufficiently low partial pressure of carbon dioxide is available for this “stripping”. Such a gas is, for example, a flue gas having a carbon dioxide partial pressure of about 0.15 bar (NTP). The problem here is that the power of the auxiliary adsorption column (the core of patent FI 124 060) is reduced as the partial pressure of carbon dioxide in the raw gas increases, since the partial pressure difference with the partial pressure of water leaving the desorption column is reduced. Furthermore, when operating according to patent FI 124 060, the partial pressure of the carbon dioxide of the water entering the absorption tank cannot be lowered than the partial pressure of the carbon dioxide of the raw gas. This reduces the carbon dioxide recovery rate of the process when there is a moderate amount of carbon dioxide remaining in the water.

### DESCRIPTION OF THE INVENTION

It is an object of the invention to provide a more economical as well as more efficient method for recovering carbon dioxide than prior art. The method and the system are characterized by what is disclosed in the independent claims. Preferred embodiments are disclosed in the dependent claims.

The invention is based on the finding that a much more efficient process can be achieved by dividing the desorption into two steps. Thus, two desorption tanks are used, one of which operates at a lower pressure than the first. Desorption tanks are arranged sequentially. The inventor found that this is particularly advantageous if the carbon dioxide concentration of the raw gas containing carbon dioxide is at least about 55%, or at least 60%. Thus, desorption occurs at almost air pressure in the first desorption tank and energy is saved when a hard under pressure is not required in the first desorption tank. The pre-desorption step can further enhance the efficiency of the process.

The invention thus relates to a method for recovering carbon dioxide. The method according to the invention comprises steps of:
pressurizing gas containing carbon dioxide,
supplying pressurized gas to an absorption step, wherein carbon dioxide contained in the pressurized gas is absorbed into water in an absorption tank,
circulating the water produced in the absorption step, into which water carbon dioxide is absorbed, from the absorption tank to a desorption step, in which the carbon dioxide absorbed in water is desorbed from water, and
recovering carbon dioxide desorbed from water,

wherein, in the desorption step, carbon dioxide absorbed in water is desorbed from water by a first desorption tank and a second desorption tank, wherein a lower pressure is applied in the second desorption tank than in the first desorption tank.

The invention also relates to a system for recovering carbon dioxide. The system according to the invention comprises:
pressurizing means for pressurizing gas containing carbon dioxide,
an absorption tank (0) for absorbing into water the carbon dioxide contained in a gas pressurized with the pressurizing means, and means for supplying pressurized gas into the absorption tank (0),
a first desorption tank (2) for desorbing from water the carbon dioxide absorbed in water,
means for circulating water from the absorption tank (0) to the desorption step,
recovering means for recovering the carbon dioxide to be desorbed from the water

wherein the system comprises a second desorption tank (3) arranged after the first desorption tank (2) and means for circulating water from the first desorption tank (2) to the second desorption tank (3), and wherein the system also comprises means for producing under pressure in at least the second desorption tank (3).

The invention provides the following advantages:
the first desorption step is carried out at reduced cost without under pressure, only in the second desorption step under pressure is applied,
saves energy and facilitates process control since the under-pressure pump is designed for a much lower output,
the required under pressure capacity depends only on the circulation water, since the first desorption tank always removes carbon dioxide so that only the partial carbon dioxide partial pressure (g/I) dependent on the pressure in the first desorption tank is left in the circulation water,
no fill block column is required to enhance the recovery process, and
if desired, the carbon recovery rate of the process may be improved than using an auxiliary adsorption column.

### BRIEF DESCRIPTION OF THE DRAWINGS

The invention will now be described in detail by way of example with reference to the accompanying drawings, in which:

FIG. 1 shows the recovery rates, production costs, and capacities depending on the amount of carbon dioxide (CO2) in the supply gas. The solubility of carbon dioxide in water depends on the pressure used and the temperature of the water. FIG. 1 shows how partial pressure strongly affects dissolution. A steep upward, almost straight line shows how the carbon dioxide recovery capacity of a carbon dioxide recovery line changes as a function of the supply gas concentration. The line represents the results of the modeling and the larger points on the curve represent the actual measurement at the point in question.

FIG. 2 shows a system according to an embodiment of the invention (example 1).

FIG. 3 shows a system according to an embodiment of the invention (example 2).

FIG. 4 shows a system according to an embodiment of the invention (example 3).

FIG. 5 shows a system according to an embodiment of the invention (example 4).

### DETAILED DESCRIPTION OF THE INVENTION

Prior art publications relate to the use of gases with a low carbon dioxide concentration, typically for example, for utilization of the power plant flue gases. The carbon dioxide concentration of the power plant flue gas is determined by the carbon dioxide produced by the combustion air and is often limited to 10-15%. This is because the purity of the combustion requires the use of extra air, so that carbon dioxide is diluted. The central problem here is the raising of the partial pressure of carbon dioxide, which is what these patents are about. On the other hand, if the carbon dioxide concentration is high, such as 60-85%, new problems arise which can be solved particularly well by the solutions according to the present invention.

The auxiliary adsorption column described in the prior art can advantageously remove the carbon dioxide remaining in the circulating water desorption column when a raw gas with a sufficiently low partial pressure of carbon dioxide is available for this “stripping”. Such a gas is, for example, a flue gas having a carbon dioxide partial pressure of about 0.15 bar (NTP).

Another case is that of raw gases with significantly higher carbon dioxide concentration. For example, in the recycling of packaging gases (carbon dioxide gas used for filling soft drinks), the carbon dioxide concentration may be, for example, 80%, with a partial pressure of carbon dioxide of about 0.80 bar (NTP).

There are many possibilities for recovery and utilization of carbon dioxide, but they can be divided into the following categories:
1. Usage as a displacement gas for oxygen.
An example of this is the packaging of meat so that carbon dioxide acts as a protective gas to prevent oxygen from entering the food. Also, as a fire extinguishing gas, carbon dioxide prevents the entry of oxygen and extinguishes the fire seat.
2. Usage as a raw material for another substance.
Carbon dioxide can be used, for example, in the manufacture of plastics or fuels, in which case carbon dioxide forms a chemical bond with other elements, in the so-called synthesis process.
3. In a greenhouse carbon dioxide as a fertilizer.
Plant photosynthesis requires carbon dioxide. In nature, this is done by plants using carbon dioxide and light, with the leaf green acting as a catalyst. In this way, the plants grow to form fibers in the structure and fruits of the plant.
4. Usage as a bubbling gas in beverages.
Carbon dioxide is formed or added to soft drinks, beer and, for example, sparkling wine to effect bubbling.

It is always profitable to recover carbon dioxide if it can be used close to the recovery point. This is because carbon dioxide requires liquefaction if transported further. By liquefaction, transportation can be can significantly enhanced. However, liquefaction and transport usually cost much more than actual recovery.

In the recovery of carbon dioxide, it is absorbed into a medium, for example water. This event is determined by the so-called Henry's Law. According to it, carbon dioxide dissolves in water directly proportional to the dissolution constant times the partial pressure of the gas. In addition, dissolution depends on the pressure used and the temperature of the water.

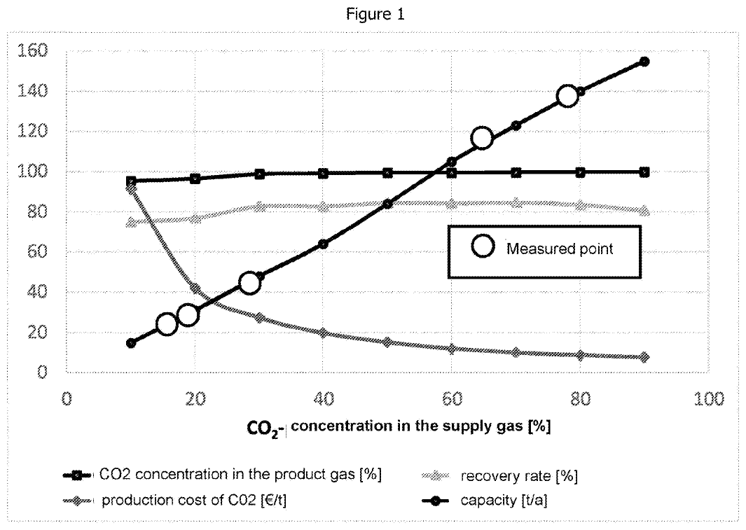

FIG. 1 shows how the carbon dioxide recovery capacity of experiments performed with the exactly same apparatus according to the invention changes directly as a function of the concentration of the supply gas, i.e. the as a function of partial pressure. Thus, it is much more advantageous to recover carbon dioxide if its concentration has been higher already at the beginning. This is advantageous, for example, in the fermentation process, which produces carbon dioxide with concentration up to 90%. If a (supply) gas with a carbon dioxide concentration of about 60% to 70% is used in the process and system according to the invention, the solution according to the invention already provides excellent results. Thus, according to the graph, the efficiency of the same plant is with a supply gas concentration of 9% 15t/a and with a supply gas of 90% 150t/a, i.e. tenfold. With a tenfold concentration of the supply gas, the efficiency of the line is also tenfold.

For example, if carbon dioxide is recovered at a soft drink plant, it is advisable to use canning shielding gas, rather than, for example, flue gas from a plant power plant. The purity requirements for canning also support this. Carbon dioxide used in canning is constantly “escaping” in small amounts, so more is needed. This supplement can come from fermentation gas or even purchased carbon dioxide, because if the majority is inexpensive recirculated gas, a small portion may be even more expensive. Also, in other processes, it is advantageous to recirculate used carbon dioxide and to purify it to 99 to 99.9% after each use.

A method for recovering carbon dioxide from a gas containing it according to the invention comprises:
pressurizing gas containing carbon dioxide,
supplying pressurized gas to an absorption step, wherein carbon dioxide contained in the pressurized gas is absorbed into water in an absorption tank,
circulating the water produced in the absorption step, into which water carbon dioxide is absorbed, from the absorption tank to a desorption step, in which the carbon dioxide absorbed in water is desorbed from water, and
recovering carbon dioxide desorbed from water,

wherein, in the desorption step, carbon dioxide absorbed in water is desorbed from water by a first desorption tank and a second desorption tank, wherein a lower pressure is applied in the second desorption tank than in the first desorption tank.

A system for recovering carbon dioxide from a gas containing it according to the invention comprises:
pressurizing means for pressurizing gas containing carbon dioxide,
an absorption tank (0) for absorbing into water the carbon dioxide contained in a gas pressurized with the pressurizing means, and means for supplying pressurized gas into the absorption tank (0),
a first desorption tank (2) for desorbing from water the carbon dioxide absorbed in water,
means for circulating water from the absorption tank (0) to the desorption step,
recovering means for recovering the carbon dioxide to be desorbed from the water wherein the system comprises a second desorption tank (3) arranged after the first desorption tank (2) and means for circulating water from the first desorption tank (2) to the second desorption tank (3), and wherein the system also comprises means for producing under pressure in at least the second desorption tank (3).

In a method and a system according to the present invention, the partial pressure of the carbon dioxide of the water leaving the first desorption tank is typically 0.5-1.1 bar (depending on the pressure applied), e.g. 1.0-1.3 bar or 1.0-1.1 bar when the partial pressure of the carbon dioxide of the raw gas is >0.6 bar. Thus, desorption occurs at near air pressure and energy is saved when the under pressure does not have to be done with an under-pressure pump.

A problem with the auxiliary adsorption column according to the prior art is that the efficiency decreases the higher the partial pressure of carbon dioxide in the raw gas increases, as the partial pressure difference with the partial pressure of water leaving the desorption column decreases. In addition, in some solutions, the partial pressure of the carbon dioxide of the water entering the absorption tank cannot be reduced below the partial pressure of the carbon dioxide of the raw gas. Thus, the recovery rate of carbon dioxide of the process decreases when a reasonable amount of carbon dioxide remains in the water to be absorbed. For example, a carbon dioxide partial pressure of 0.8 bar corresponds to a solubility of about 2.2 g/l of carbon dioxide in water at normal pressure and at temperature of +5° C. The conditions described above are typical for an auxiliary adsorption column. The present invention provides a solution to this problem.

In the prior art solutions, auxiliary desorption columns utilize fill blocks whose inner surfaces are good substrates for microbes. The use of fill blocks is not advantageous in all applications, such as the food and beverage industry, where hygiene requirements are high, as thorough cleaning is challenging.

For the above reasons, a solution according to the present invention was invented. The invention provides another way of removing carbon dioxide gas from water, which can be operated advantageously, although the partial pressure of carbon dioxide of the raw gas is >0.6 bar (NTP) and the hygiene requirements are high. By using the solution according to the invention with two successive desorption tanks, the use of fill blocks can be avoided.

According to a preferred embodiment, at least one of the first desorption tank (2) and the second desorption tank (3) comprise shapes which force the water to move upwards. Preferably, the shape is a structure within the tank which is a vertical partition wall, and which starts at the bottom. The height of the partition wall is preferably less than halfway up the tank in the height direction. With the help of a partition wall, the surface area of the bottom of the tank is divided (by the partition wall) in the desired ratio, e.g. 50/50. By using the partition ratio, the velocity of water in the parts of the tank divided by partition wall can be influenced. However, the surface of the tank must be kept above the partition wall to ensure that pressurized gas cannot escape from the water outlet to the wrong tank. In the partition wall solution described above, water is entered from the lower part of the tank and drained from the other side of the partition wall from the lower part of the tank.

According to an embodiment, the solution according to the invention further comprises a pre-desorption step, wherein the pre-desorption step is carried out in a pre-desorption tank, from which water is led to a first desorption tank. The pre-sorption step can be carried out e.g. in a flash tank. From a pre-adsorption tank, water is led to a first desorption tank. In this way, cost efficiency is increased, and carbon dioxide can be removed up to a pressure of 1 bar, which accounts for most of the product gas.

Thus, according to an embodiment, the system also comprises a pre-desorption tank (1) arranged prior to the first desorption tank (2) and means for circulating water from the pre-desorption tank to the first desorption tank. Also, the pre-desorption tank may comprise the shapes defined above which force the water to move upwards. The shapes are advantageous in the pre-desorption tank because the bubbles of impurity gases must be separated as well as possible at that step.

According to an embodiment, the absolute pressure of a first desorption tank is in the range of 0.9-2.5 bar, preferably 1.0-1.5 bar, more preferably 1.0-1.3 bar, and the absolute pressure of a second desorption tank is in the range of 0.05-0.9 bar, preferably 0.1-0.8 bar, more preferably 0.3-0.6 bar. The absolute pressure may also be, for example, 0.2 bar, 0.4 bar or 0.5 bar.

According to an embodiment, said carbon dioxide-containing gas has a carbon dioxide concentration of at least 55%, preferably at least 60%, more preferably at least 70%, and most preferably at least 80%. Percentage values refer to partial pressure percentages.

According to an embodiment, in the at least one desorption tank an absolute pressure substantially equal to air pressure is applied, preferably 1.0-1.5 bar. The pressure may also be, for example, 1.1 bar, 1.2 bar, 1.3 bar or 1.4 bar.

According to an embodiment, in the first desorption tank an absolute pressure substantially equal to air pressure is applied, wherein the pressure is preferably in the range of 1.0-1.5 bar. The pressure may also be, for example, 1.1 bar, 1.2 bar, 1.3 bar or 1.4 bar.

According to an embodiment, the pressure difference between the first desorption tank and the second desorption tank is in the range of 0.5-2.45 bar, preferably in the range of 0.5-1.5 bar. The pressure difference may also be, for example, 0.6 bar, 0.7 bar, 0.8 bar, 0.9 bar, 1.0 bar, 1.1 bar, 1.2 bar, 1.3 bar, or 1.4 bars.

According to an embodiment, at least one desorption tank is provided with a surface mixer.

According to an embodiment, at least one desorption tank is provided with an ultrasonic source to release carbon dioxide dissolved in water.

According to an embodiment, the water in the second desorption tank is warmer than in the first desorption tank. This can be used to enhance the desorption step.

According to an embodiment, the water is first directed upwardly in at least one desorption tank. Preferably, the water is first directed to move upwards at least in both the first and second desorption tanks. This facilitates the release of carbon dioxide from the water.

According to an embodiment, the desorption tanks do not include fill blocks.

According to an embodiment, the method according to the invention does not include an auxiliary desorption step. Accordingly, the system according to the invention does not include an auxiliary desorption tank or column.

In the context of this invention, “absorption tank” means any absorption tank or absorption column applicable for a method according to the invention, e.g. a bubble column.

In the context of this invention, “desorption tank” means any desorption tank or desorption column applicable for a method according to the invention.

According to an embodiment, the solution according to the invention also comprises at least one compressor. The system may also comprise two or at least two compressors. Compressors are advantageous especially if the carbon dioxide supply is uneven (e.g. in the brewing industry and especially in beer production). They can be used to control the amount of carbon dioxide entering the system.

According to an embodiment, the solution according to the invention also comprises a sack storage. A sack storage is used to store (raw) gas containing carbon dioxide. A sack storage is, for example, a non-pressurized storage of raw gas made of polyester fiber (and coated with polyurethane). In a typical application, for example in breweries, the supply flow rate of the raw gas varies greatly, so that by measuring the height of the sack surface, the capacity of the recovery process can be adjusted downwards or upwards as needed.

According to a preferred embodiment, the solution according to the invention also comprises a pumping tank (4). The pumping tank ensures that the water moves if the system pressure differences are not enough to move the water without separate pumping. The water passing through the process circuit is collected in a pumping tank, from where it is pumped by means of a circulating pump to the pressure in the absorption tank. The pressure in the pumping tank is close to air pressure. The pumping tank is preferably provided with a partition wall. The partition wall separates the gas and water space. The partition wall can be used to form a “ceiling”, whereby the upper part of the pumping tank is separated. This upper part may serve as a mixing space for gas.

According to a preferred embodiment, the pressure difference is distributed as evenly as possible between the desorption tanks. This way, the extra pumping power is at its minimum.

This is obtained by utilizing the hydrostatic pressure so that the highest pressure is in the lowermost tank and the lowest in the uppermost. Also, the total pressure difference between successive desorption steps is sufficiently large. The total pressure difference depends on the pressures in the tanks, as well as the height difference and pressure drop between the tanks.

Tanks for the carbon dioxide recovery system according to the invention may be disposed at different locations relative to one another. There are different types of low-cost investment combinations, and the most important thing is to consider the whole and optimize the process accordingly. The tanks can be disposed at different heights or they can all be on the same level, with no difference in height.

In a method according to an invention, a more specific description of a preferred embodiment is as follows:
The carbon dioxide-containing (raw) gas enters the upper part of the pumping tank, where it is mixed with gas released from pre-desorption (i.e., from a flash tank). The mixed gas from the upper part of the pumping tank and the gas in the pre-desorption tank, which is called the absorption gas, continues through the compressor as pressurized into an absorption tank where carbon dioxide is dissolved from the gas to water. In the absorption tank, water and gas flow upstream so that absorption is as complete as possible. Insoluble waste gas is removed from the upper part of the absorption tank and carbon dioxide-containing water at the lower part continues to the pre-desorption tank where oxygen and nitrogen are removed from the water by lowering pressure.
Less water-soluble gases, such as oxygen and nitrogen, are removed from the water by more than carbon dioxide in desorption. On the other hand, in absorption, oxygen and nitrogen are less soluble in water relative to carbon dioxide. The Henry's constants of the gases [I*atm/mol] at +5° C. in water are approximately CO₂/O₂/N₂=16/536/1124, whereby carbon dioxide is soluble in water about 34 times better than oxygen and about 70 times better than nitrogen. The carbon dioxide is then enriched in the circulating water as the absorption gas passes through the absorption tank. On the other hand, the composition of the gas released from the pre-desorption tank is in accordance with the proportions of solutes (partial pressure effect) according to Henry's law. As the carbon dioxide of the absorption gas is enriched in the circulating water, the carbon dioxide concentration of the pre-desorption gas is higher than the carbon dioxide concentration of the absorption gas, which makes it very profitable to recycle it back to the pumping tank. The concentration of the gas to be absorbed, and on the other hand the solubility of the carbon dioxide in the circulating water after the absorption tank, can be adjusted by varying the pre-desorption pressure. Also, the purity of the product gas can be adjusted by varying the pre-desorption pressure, since the lower the pre-desorption pressure used, the less impure gases are contained in the circulating water going into the actual desorption. Circulation of the pre-desorption gas back, for example, causes a delay in the start-up phase of the process before the process reaches a steady state, whereby the circulating water is “charged” by carbon dioxide. Circulating, in general, increases the slowness of the process and makes it more difficult to be predictable. The process according to this patent has one circulating less than the prior art process.
The circulating water from the pre-desorption tank continues to the first desorption tank where the carbon dioxide can advantageously be removed up to a pressure of about 1 bar, which constitutes most of the product gas, since the pressure drop from the pre-desorption tank is preferably Δp=2-3 bar. However, in this case about 3 g/l of carbon dioxide remain in the water whereby for the efficiency of the process, it is advisable to remove the carbon dioxide from the circulated water. From the first desorption tank, water continues to the second desorption tank according to the invention, which utilizes under pressure of about 0.4-0.8 bar. In this case, the pressure drop from the pressure in the first desorption tank is only about Δp=0.2-0.6 bar, so that the amount of gas released is considerably smaller than in the first desorption tank. The second desorption tank removes as much carbon dioxide from the water as is economically viable. From the second desorption tank, the circulating water continues to the pumping tank and starts a new cycle.
According to a preferred embodiment, the absorption gas and the “regenerated” water are not combined in the same space. However, if they are combined, it is preferable to have a sealed partition wall between the gas mixing space (where the carbon dioxide containing (raw) gas and the pre-desorption gas are mixed) and the water pumping space. This is because the water that has undergone the desorption steps is under-saturated even with the raw gas, and even more under-saturated when the pre-desorption gas is mixed with the raw gas. In this case, some carbon dioxide is already soluble in water in the pumping tank.

Advantages of the present invention include that when desorption is divided into two steps, the first step can be performed without low under pressure at a lower cost and only the second step uses a lower under pressure and a more efficient pump. This saves energy and facilitates process control as the under-pressure pump is designed for a much lower output. In addition, the required under pressure capacity depends only on the circulation water flow, since some carbon dioxide is always removed in the first desorption tank. Generally, the amount of carbon dioxide is such that only the partial pressure of carbon dioxide (g/I) dependent on the pressure in the first desorption tank is left in the circulating water. This makes the under-pressure pump sizing easier, for example, fluctuations in the raw gas concentration do not affect the under-pressure pump capacity.

In the auxiliary desorption column according to the prior art, the carbon dioxide released from the water is returned to the beginning of the gas cycle and pressurized by a compressor to the pressure in the absorption tank. This increases costs because the carbon dioxide released in the auxiliary desorption column is pressurized twice. In the process according to the present invention, this is not done, but the carbon dioxide is removed from the gas cycle by using under pressure. This removes one recirculation from the process, the disadvantages of which were previously mentioned. Cost refers here to the specific energy consumption of the process, expressed in MWh/ton of carbon dioxide.

In the system for recovery of carbon dioxide, control parameters, heat pumps, water flow, etc. may be controlled in each situation in an economically optimized way. According to an embodiment, the absolute pressure used in the absorption tank is 1-15 bar, preferably 2-12 bar, more preferably 3-10 bar, such as, for example, 5-7 bar, such as 4.8-5.2 bar. According to an embodiment, the water to be added to the absorption tank has a usable temperature of less than 10° C., preferably less than 5° C.

According to an embodiment, the under pressure applied in the second desorption tank is less than 0.8 bar, more preferably less than 0.5 bar, more preferably less than 0.3 bar. Suitable pressures, temperatures, etc., will depend upon the entity as a whole and may be other than the above.

According to a preferred embodiment, the pressure of the second desorption tank is lowered to a level of at least 0.6 bar. This greatly increases the efficiency of the process and increases desorption.

According to a preferred embodiment, the carbon dioxide desorbed from the desorption tank is circulated back to the absorption tank.

According to a preferred embodiment, the gas is heated, or water is cooled for increasing absorption.

According to an embodiment, at least part of the carbon dioxide exiting the desorption tank is liquefied and optionally distilled for recovery.

Carbon dioxide is recovered, for example, in the beer and soft drinks industry. Carbon dioxide must be recovered from, for example, fermentation tank gas. In this case, carbon dioxide is usually dissolved in water. In an advantageous embodiment of the invention, the method for recovering carbon dioxide is carried out in a beer and/or soft drink plant, e.g. from a fermentation tank.

In an embodiment of the invention, the carbon dioxide desorbed from one of the desorption tanks is circulated back to the absorption tank.

In some preferred embodiments, the gas is heated, or water is cooled to increase absorption. Correspondingly, water is heated in a pre-desorption tank (e.g. in a so-called flash tank) and/or in desorption to separate the CO₂ gases. This enhances the absorption and release of carbon dioxide.

In an embodiment of the method, water in the absorption tank is mixed with a mixer that causes the water to circulate in the absorption tank by throwing it into the air space of the absorption tank and spreading it over, as wide area as possible, in the air space of the absorption tank. This provides the most efficient absorption of the carbon dioxide-containing gas into the water mass contained in the absorption tank.

According to an embodiment of the invention, water in the absorption tank is mixed with a mixer comprising a motor, a drive shaft and at least one propeller located near the water surface at a depth where the hydrostatic pressure of the water is non-existent or almost non-existent. The motor is preferably an electric motor.

The method according to the invention can be implemented in a system where the absorption tank is provided with a mixer, a task of which is to circulate water in the absorption tank by throwing it into the air space of the absorption tank and spreading it over, as wide area as possible, in the air space of the absorption tank. In this way, the carbon dioxide contained in the gas containing carbon dioxide can be absorbed as efficiently as possible into the water mass contained in the absorption tank.

In an advantageous embodiment of the system, there is a pre-reactor between the pressurizing means and the absorption tank, into which the pressurized gas and water returning back from the desorption tank to the absorption tank are supplied, and in which the pressurized gas and water returned from the desorption tank are mixed by the mixing effect resulting from their mutual flow rate differences. The advantage of this is that there is no need to bring external energy for pre-mixing and that the system's own energy is utilized.

In another embodiment of the system, a feedback is provided after the recovery means for carbon dioxide desorbed from water in one of the desorption tanks to circulate at least a portion of the desorbed carbon dioxide back into the absorption tank through a pre-reactor.

This yields pure carbon dioxide among the raw gas, thereby increasing the partial pressure of carbon dioxide and the absorption is improved in the same relation according to Henry's law.

It is also advantageous that the system is provided with, after the gas pressurizing means, with a first heat pump, whose condenser allows the pressurized gas to be heated before being mixed with water. Further, it is advantageous that the evaporator of the first heat pump cools the water exiting the desorption tank before returning it back to the absorption tank. The hotter the gas and/or the colder the water, the more effective is the carbon dioxide absorption in the water.

In another preferred embodiment of the system, after the absorption tank, there is a second heat pump whose condenser allows the water exiting the absorption tank to be heated before being introduced into the desorption step. The warmer the water in the desorption tank, the more effective is the desorption of carbon dioxide from the water. In the present invention it is particularly advantageous if the water of the second desorption step is warmer than that of the first.

In a yet another preferred embodiment of the system, the system is provided with a third heat pump having an evaporator located between the second heat pump evaporator and the first heat pump evaporator, by means of which friction or other excess heat introduced into the system by another process equipment can be removed from the system and transferred to its environment or to other utilization.

It is further advantageous that the system is provided with a fourth heat pump having a condenser which in the water circulation direction is located between the condenser of the second heat pump and a desorption tank, and through which evaporator the gas, from which carbon dioxide is absorbed into water in the absorption tank, passes through before exiting the system. This allows to recover the heat of the gas in question to heat the water that has absorbed the carbon dioxide entering the desorption tank.

### EXAMPLES

### Example 1

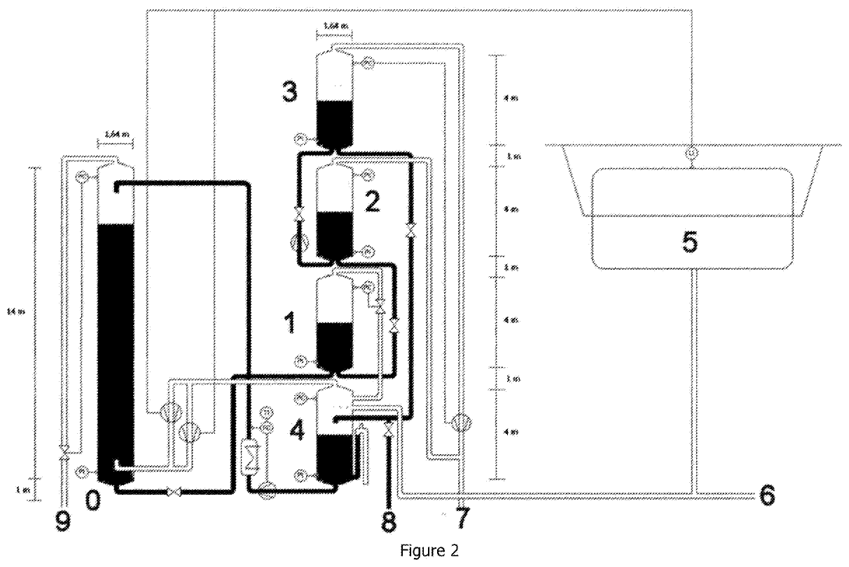

FIG. 2 shows a modeling of a system according to an embodiment:
0 Absorption tank (pressure about 6 bar)
1 Pre-desorption tank (Flash tank) (pressure about 3.7 bar)
2 Desorption tank 1 (pressure about 1.3 bar)
3 Desorption tank 2 (pressure about 0.8 bar)
4 Pumping tank (pressure about 1 bar)
5 Sack storage (approx. 120 m³, D=4.5 m, L=9 m)
6 Raw gas
7 Product gas
8 Fresh water
9 Exhaust gas

The carbon dioxide-containing (raw) gas enters the upper part of the pumping tank, where it is mixed with gas released from pre-desorption (1), e.g. from a flash tank. The mixed gas from the upper part of the pumping tank (4) and the flash tank gas, which is called the absorption gas, continue through the compressor as pressurized to the absorption tank (0), where carbon dioxide is dissolved from the gas to water. In the absorption tank, water and gas flow upstream so that absorption is as complete as possible. Insoluble waste gas is removed from the upper part of the absorption tank and carbon dioxide-containing water at the lower part continues to pre-desorption (to a flash tank) where oxygen and nitrogen are removed from the water by lowering the pressure.

Circulating water from the flash tank continues to the first desorption tank, where carbon dioxide can advantageously be removed up to a pressure of about 1 bar, which accounts for most of the product gas, since the pressure drop from the flash tank pressure is of the order Δp=2-3 bar. However, in this case about 3 g/l of carbon dioxide remain in the water whereby for the efficiency of the process, it is advisable to remove the carbon dioxide from the circulating water. From the first desorption tank, water continues to the second desorption tank, which utilizes a under pressure of about 0.4-0.8 bar. Thus, the pressure drop from the pressure in the first desorption tank is only about Δp=0.2-0.6 bar, so that the amount of gas released is considerably smaller than in the first desorption tank. The second desorption tank removes as much carbon dioxide from the water as is economically viable. From the second desorption tank, the circulating water continues to the pumping tank and starts a new cycle.

In the example, the height difference between tanks 0 and 1 is about 5 meters, the height difference between tanks 1 and 2 is about 5 meters, the height difference between tanks 2 and 3 is about 5 meters, and the height difference between tanks 3 and 4 is about 12 meters. The height of the structure is about 20 m.

### Example 2

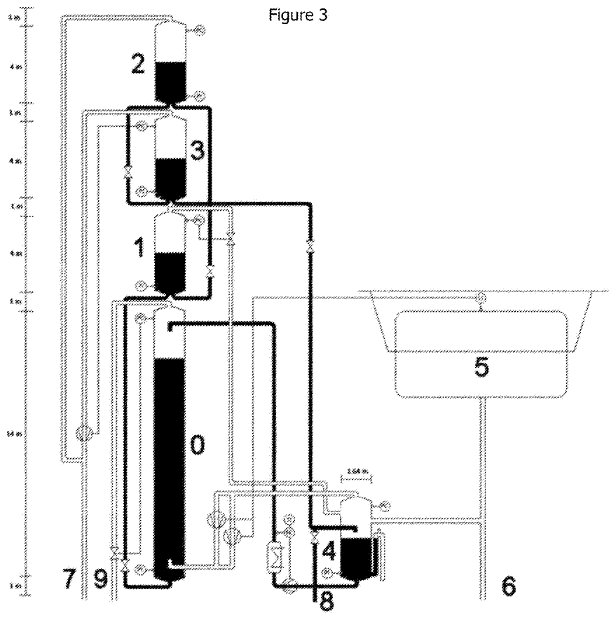

FIG. 3 shows a modeling of a system according to an embodiment.

The description is the same as in Example 1 but with a new placement. In Example 2, the height difference between tanks 0 and 1 is about 15 meters, the height difference between tanks 1 and 2 is about 10 meters, the height difference between tanks 2 and 3 is about 5 meters, and the height difference between tanks 3 and 4 is about 17 meters. The height of the structure is about 30 m.

### Example 3

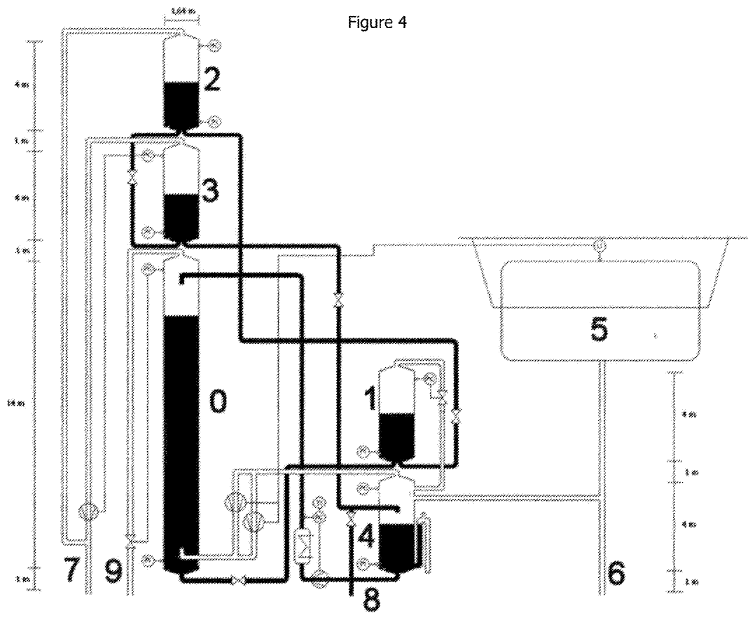

FIG. 4 shows a modeling of a system according to an embodiment.

The description is the same as in Example 1 but with a new placement. In Example 3, the height difference between tanks 0 and 1 is about 5 meters, the height difference between tanks 1 and 2 is about 15 meters, the height difference between tanks 2 and 3 is about 5 meters, and the height difference between tanks 3 and 4 is about 12 meters. The height of the structure is about 25 m.

### Example 4

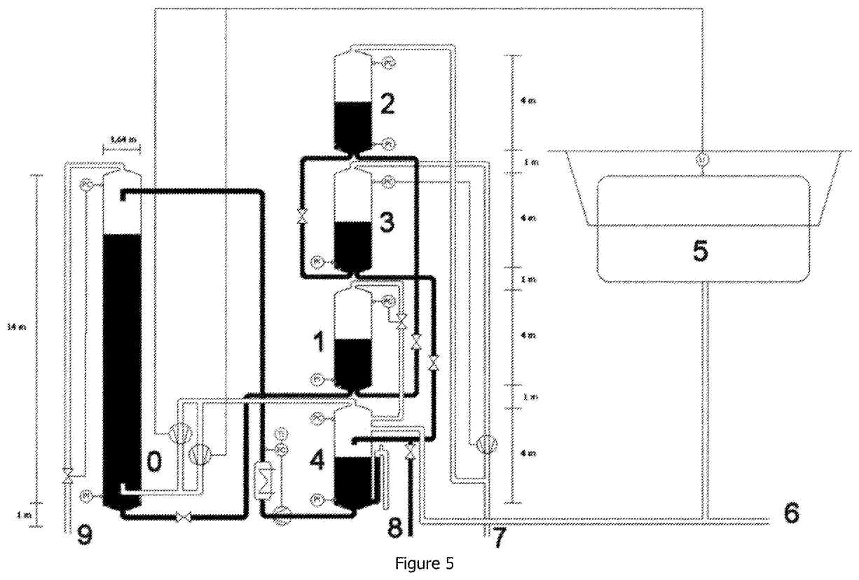

FIG. 5 shows a modeling of a system according to an embodiment.

The description is the same as in Example 1 but with a new placement. In Example 4, the height difference between tanks 0 and 1 is about 5 meters, the height difference between tanks 1 and 2 is about 10 meters, the height difference between tanks 2 and 3 is about 5 meters, and the height difference between tanks 3 and 4 is about 7 meters. The height of the structure is about 20 m.

1. A method for recovering carbon dioxide from a gas containing carbon dioxide, the method comprising:
pressurizing the gas containing the carbon dioxide,
supplying the pressurized gas to an absorption step, wherein the carbon dioxide contained in the pressurized gas is absorbed into water in an absorption tank,
circulating the water produced in the absorption step, into which water at least some of the carbon dioxide is absorbed, from the absorption tank to a desorption step, in which the carbon dioxide absorbed in water is desorbed from the water, and
recovering the carbon dioxide desorbed from water,
wherein in the desorption step, carbon dioxide absorbed in the water is desorbed from the water by means of a first desorption tank and a second desorption tank, wherein a lower pressure is applied in the second desorption tank than in the first desorption tank.

2. The method for recovering carbon dioxide according to claim 1, wherein the absolute pressure of the first desorption tank is in the range of 0.9-2.5 bar, and the absolute pressure of the second desorption tank is in the range of 0.05-0.9 bar.

3. The method for recovering carbon dioxide according to claim 1 wherein said carbon dioxide-containing gas has a carbon dioxide concentration of at least of one at least 55%, at least 60%, at least 70%, or at least 80%.

4. The method for recovering carbon dioxide according to claim 1, wherein in the at least one desorption tank, an absolute pressure substantially equivalent to at least on of air pressure, or 1.0-1.5 bar, is applied.

5. The method for recovering carbon dioxide according to claim 1, wherein in the first desorption tank, an absolute pressure substantially equal to at least one of air pressure or in the range of 1.0-1.5 bar, is applied.

6. The method for recovering carbon dioxide according to claim 1, wherein the pressure difference between the first desorption tank and the second desorption tank is in the range of at least one of 0.5-2.45 bar, or 0.5-1.5 bar.

7. The method for recovering carbon dioxide according to claim 1, wherein a surface mixer is present in at least one desorption tank.

8. The method for recovering carbon dioxide according to claim 1, wherein in an ultrasonic source to release carbon dioxide dissolved in water is present in at least one desorption tank.

9. The method for recovering carbon dioxide according to claim 1 wherein the water in the second desorption tank is warmer than the water in the first desorption tank.

10. The method for recovering carbon dioxide according to claim 1, wherein the method further comprises a pre-desorption step, wherein the pre-desorption step is carried out in a pre-desorption tank, from which water is led to a first desorption tank.

11. The method for recovering carbon dioxide according to claim 1, wherein the water is first directed upwardly in at least one desorption tank, of the first and second desorption tanks.

12. The method for recovering carbon dioxide according to claim 1, wherein the desorption tanks do not include fill blocks.

13. A system for recovering carbon dioxide from a gas containing carbon dioxide, comprising:
pressurizing means for pressurizing gas containing carbon dioxide,
an absorption tank for absorbing into water the carbon dioxide contained in the gas pressurized with the pressurizing means, and
means for supplying pressurized gas into the absorption tank,
a first desorption tank for desorbing from water the carbon dioxide absorbed in water, means for circulating water from the absorption tank to the first desorption tank, means for recovering the carbon dioxide to be desorbed from water,
a second desorption tank arranged after the first desorption tank,
means for circulating water from the first desorption tank to the second desorption tank, and
means for producing under pressure in at least the second desorption tank.

14. The system for recovering carbon dioxide according to claim 13, further comprising a pre-desorption tank arranged before the first desorption tank and means for circulating water from the pre-desorption tank to the first desorption tank.

15. The system for recovering carbon dioxide according to claim 13, wherein at least one of the first desorption tank and the second desorption tank is provided with shapes which force the water to move upwards.

16. The system for recovering carbon dioxide according to claim 13, wherein the system also comprises a pumping tank.

17. The method for recovering carbon dioxide according to claim 1, wherein the absolute pressure of the first desorption tank is in the range of 1.0-1.5 bar, and the absolute pressure of the second desorption tank is in the range of 0.1-0.8 bar.

18. The method for recovering carbon dioxide according to claim 1, wherein the absolute pressure of the first desorption tank is in the range of 1.0-1.3 bar, and the absolute pressure of the second desorption tank is in the range of 0.3-0.6 bar.
